(19) United States
(12) Patent Application Publication
(10) Pub. No.: US 2023/0050753 A1
(43) Pub. Date: Feb. 16, 2023

(54) METHOD AND SERVER FOR PROVIDING SERVICE TO A CLIENT FROM AN INDEPENDENT CONTRACTOR

(71) Applicant: TrunkDrop LLC, St. Paul, MN (US)

(72) Inventors: Lance Conger, Eden Prairie, MN (US); James Kruse, Eden Prairie, MN (US); Jon Schoen, Eden Prairie, MN (US)

(21) Appl. No.: 17/886,962

(22) Filed: Aug. 12, 2022

Related U.S. Application Data
(60) Provisional application No. 63/232,864, filed on Aug. 13, 2021.

(51) Int. Cl. G06Q 10/06; G06Q 10/10

(52) U.S. Cl. CPC G06Q 10/06311; G06Q 10/1053; G06Q 50/10

(57) ABSTRACT

A technique for connecting independent contractors to clients is described. A server receives, from a first contractor device, a request to add a first independent contractor to a database including a plurality of independent contractors. The server prompts the first contractor device for information descriptive of the first independent contractor including an hourly wage for the first independent contractor. The server receives the information and adds the first independent contractor to the database and the plurality of independent contractors. The server receives, from a client device, a request to view at least a portion of the plurality of independent contractors. The server sends the client device at least the portion of the plurality of independent contractors and respective information for each independent contractor included in the portion of the plurality of independent contractors, wherein the portion of the plurality of independent contractors includes the first independent contractor.

This application claims the benefit of U.S. Provisional Application No. 63/232,864, filed Aug. 12, 2021, the entire contents of which are incorporated herein.

### BACKGROUND

As smartphones and applications for particular services become more prevalent, some companies are embroiled in legal troubles in treating persons who are legally defined as employees like they are independent contractors. For certain services, such as rideshare services and third-party food delivery services, the companies running these services allow individuals to apply for a position working for that service, set the rates for those services based on a perceived demand, and assign jobs to those working for that service. In other words, the companies treat the workers as if they are employees by defining numerous aspects of the employment without allowing the freedom of choice typically afforded to independent contractors, but classify the workers as independent contractors in order to avoid providing benefits, such as health insurance, to those workers.

### SUMMARY

In general, the disclosure is directed to a system for enabling independent contractors to define the terms of their service agreement with a company. The company can connect the independent contractors with customers seeking to hire these independent contractors for jobs, with the company using the terms defined by the independent contractors in determining total costs for the job. Should the customer accept the terms, the company creates the job contracted between the independent contractor and the customer. The initial match of independent contractors may be based on criteria defined by the customer for the job or location services gathered from global positioning system (GPS) components of one or more of the customer's device and the independent contractor's device.

This system provides numerous practical benefits. Through the incorporation of the GPS components, the server implementing the techniques described herein can more accurately calculate the potential job costs for a customer when that customer is shopping between independent contractors, as some jobs may include travel times between different locations and may begin calculating the cost based on both the location of the customer and the immediate location of the independent contractor. Additionally, through the use of the techniques described herein, a company can more successfully navigate the employment law considerations of ensuring the workers for the company are independent contractors and rightfully treated as such, as opposed to other services that treat workers more like employees without providing the benefits legally afforded to those individuals. Furthermore, by filtering the list of potential independent contractors based on specific criteria defined by the customer, the techniques described herein improve the functioning of the network and devices overall by decreasing the amount of data traversing the network and being shown on the devices.

In one example, the disclosure is directed to a method in which a server device receives from a first contractor device, a request to add a first independent contractor to a database including a plurality of independent contractors. The method further includes prompting, by the server device and on the first contractor device, for information descriptive of the first independent contractor, wherein the information includes an hourly wage for the first independent contractor. The method also includes receiving, by the server device and from the first contractor device, a first set of one or more data packets including the information descriptive of the first independent contractor. The method further includes adding, by the server device, the first independent contractor to the database and the plurality of independent contractors. The method also includes receiving, by the server device and from a client device, a request to view at least a portion of the plurality of independent contractors. The method further includes sending, by the server device and to the client device, a second set of one or more data packets including at least the portion of the plurality of independent contractors and respective information for each independent contractor included in the portion of the plurality of independent contractors, wherein the portion of the plurality of independent contractors includes the first independent contractor.

In another example, the disclosure is directed to a device comprising a memory configured to store a database, and a processor. The processor is configured to receive, from a first contractor device, a request to add a first independent contractor to the database including a plurality of independent contractors. The processor is further configured to prompt, on the first contractor device, for information descriptive of the first independent contractor, wherein the information includes an hourly wage for the first independent contractor. The processor is also configured to receive, from the first contractor device, a first set of one or more data packets including the information descriptive of the first independent contractor. The processor is further configured to add the first independent contractor to the database and the plurality of independent contractors. The processor is also configured to receive, from a client device, a request to view at least a portion of the plurality of independent contractors. The processor is further configured to send, to the client device, a second set of one or more data packets including at least the portion of the plurality of independent contractors and respective information for each independent contractor included in the portion of the plurality of independent contractors, wherein the portion of the plurality of independent contractors includes the first independent contractor.

In another example, the disclosure is directed to a non-transitory computer-readable storage medium containing instructions. The instructions, when executed, cause one or more processors to receive, from a first contractor device, a request to add a first independent contractor to a database including a plurality of independent contractors. The instructions further cause the processor to prompt, on the first contractor device, for information descriptive of the first independent contractor, wherein the information includes an hourly wage for the first independent contractor. The instructions also cause the processor to receive, from the first contractor device, a first set of one or more data packets including the information descriptive of the first independent contractor. The instructions further cause processor to add the first independent contractor to the database and the plurality of independent contractors. The instructions also cause the processor to receive, from a client device, a request to view at least a portion of the plurality of independent contractors. The instructions further cause the processor to send, to the client device, a second set of one or more data packets including at least the portion of the plurality of independent contractors and respective information for each independent contractor included in the portion of the plurality of independent contractors, wherein the portion of the plurality of independent contractors includes the first independent contractor.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating an example environment where a server device connects an independent contractor with a customer over a network, in accordance with the techniques described herein.

FIG. 2 is a block diagram illustrating a more detailed example of a computing device configured to perform the techniques described herein.

FIG. 3 is a conceptual diagram illustrating an example user interface for registering an independent contractor, in accordance with the techniques described herein.

FIG. 4 is a conceptual diagram illustrating an example user interface for matching an independent contractor with a customer, in accordance with the techniques described herein.

FIG. 5 is a conceptual diagram illustrating an example user interface for sorting a list of independent contractors, in accordance with the techniques described herein.

FIG. 6 is a conceptual diagram illustrating an example user interface for filtering a list of independent contractors, in accordance with the techniques described herein.

FIG. 7 is a conceptual diagram illustrating an example user interface for using location services in the independent contractor-customer matching process, in accordance with the techniques described herein.

FIG. 8 is a conceptual diagram illustrating an example user interface for pricing a job, in accordance with the techniques described herein.

FIG. 9 is a conceptual diagram illustrating an example user interface for rating an independent contractor after a job has completed, in accordance with the techniques described herein.

FIG. 10 is a conceptual diagram illustrating an example user interface for notifying the customer about contraband, in accordance with the techniques described herein.

FIG. 11 is a flow diagram illustrating an example technique for registering independent contractors, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

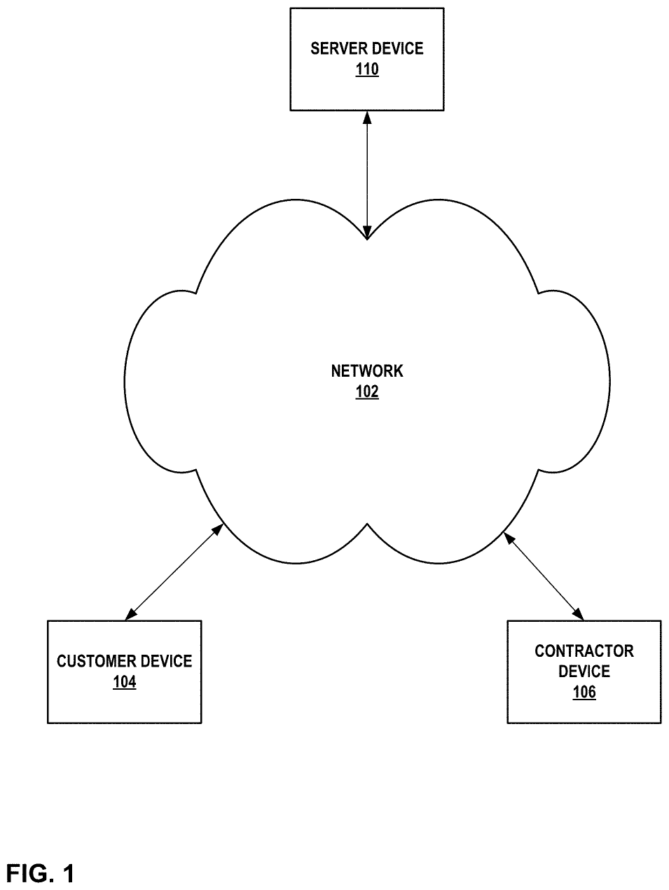

FIG. 1 is a block diagram illustrating an example environment where a server device connects an independent contractor with a customer over a network, in accordance with the techniques described herein. In the examples of FIG. 1, server device 110, customer device 104, and contractor device 106 may be in communication with one another via at least network 102. In some instances, server device 110 may act as a connecting router for communications between customer device 104 and contractor device 106. For example, customer device 104 may send a communication to server device 110 via network 102, and server device 110 may forward that communication to contractor device 106 via network 102, such as in instances where an application programming interface (API) is used on both customer device 104 and contractor device 106.

Customer device 104 (also referred to herein as a client device) may be any computer with the processing power required to adequately execute the techniques described herein. For instance, customer device 104 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Contractor device 106 may be any computer with the processing power required to adequately execute the techniques described herein. For instance, contractor device 106 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Server device 110 may be any computer with the processing power required to adequately execute the techniques described herein. For instance, server device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Network 102 may be any network capable of transmitting messages between devices. Network 102 may utilize radio transmission protocols, cellular transmission protocols, interne transmission protocols, short-wave radio transmission protocols, or any other protocol that could be used in sending messages between devices.

In accordance with the techniques described herein, server device 110 receives, from contractor device 106, a request to add a first independent contractor to a database that includes a plurality of independent contractors. Server device 110 prompts, on contractor device 106, for information descriptive of the first independent contractor. That information, among other things, may include an hourly wage for the first independent contractor. Server device 110 receives, from contractor device 106, a first set of one or more data packets including the information descriptive of the first independent contractor. Server device 110 adds the first independent contractor to the database and to the plurality of independent contractors. Server device 110 receives, from customer device 104, a request to view at least a portion of the plurality of independent contractors. Server device 110 sends, to customer device 104, a second set of one or more data packets including at least the portion of the plurality of independent contractors and respective information for each independent contractor included in the portion of the plurality of independent contractors, with the portion of the plurality of independent contractors including the first independent contractor previously added to the plurality.

This system provides numerous practical benefits. Through the incorporation of the GPS components, server device 110 can more accurately calculate the potential job costs for a customer when that customer is shopping between independent contractors, as some jobs may include travel times between different locations and may begin calculating the cost based on both the location of the customer and the immediate location of the independent contractor. Additionally, through the use of the techniques described herein, a company can more successfully navigate the employment law considerations of ensuring the workers for the company are independent contractors and rightfully treated as such, as opposed to other services that treat workers more like employees without providing the benefits legally afforded to those individuals. Furthermore, by filtering the list of potential independent contractors based on specific criteria defined by the customer, the techniques described herein improve the functioning of network 102 and devices 104, 106, and 110 overall by decreasing the amount of data traversing the network and being shown on the devices.

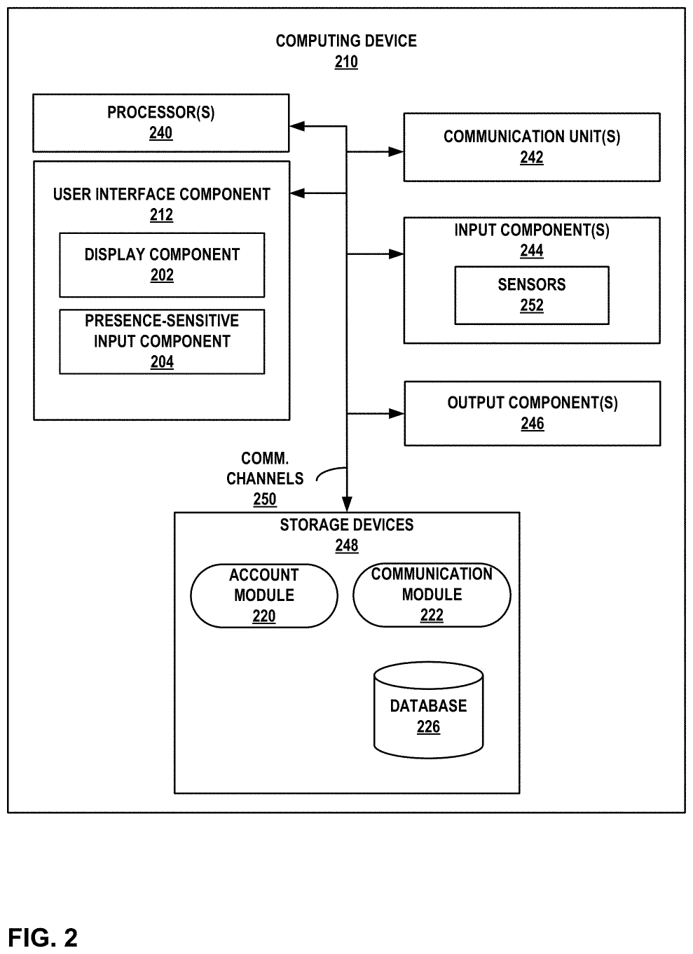

FIG. 2 is a block diagram illustrating an example computing device configured to connect independent contractors with potential customers, in accordance with one or more aspects of the techniques described in this disclosure. Computing device 210 of FIG. 2 is described below as an example of server device 110 of FIG. 1. FIG. 2 illustrates only one particular example of server device 110, and many other examples of server device 110 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include account module 220, communication module 222, and database 226.

One or more processors 240 may implement functionality and/or execute instructions associated with computing device 210 to defining independent contractors and connecting those independent contractors with customers. That is, processors 240 may implement functionality and/or execute instructions associated with computing device 210 to allow the registering of an independent contractor and the creating of a job for that independent contractor with a customer wishing to hire that independent contractor for a job.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to allow the registering of an independent contractor and the creating of a job for that independent contractor with a customer wishing to hire that independent contractor for a job.

Account module 220 may execute locally (e.g., at processors 240) to provide functions associated with registering an independent contractor in database 226 and creating jobs for customers with the independent contractor. In some examples, account module 220 may act as an interface to a remote service accessible to computing device 210. For example, account module 220 may be an interface or application programming interface (API) to a remote server that registers an independent contractor in database 226 and creates jobs for customers with the independent contractor.

In some examples, communication module 222 may execute locally (e.g., at processors 240) to provide functions associated with communicating with outside computing devices, such as a customer device and a contractor device. In some examples, communication module 222 may act as an interface to a remote service accessible to computing device 210. For example, communication module 222 may be an interface or application programming interface (API) to a remote server that communicates with outside computing devices, such as a customer device and a contractor device.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and database 226. Storage components 248 may include a memory configured to store data or other information associated with modules 220 and 222 and database 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, communication module 222 receives, from a contractor device, a request to add a first independent contractor to database 226, which includes a plurality of independent contractors. For instance, when a user wishes to be added to database 226 so that they may be assigned jobs from computing device 210 and the company that owns computing device 210, the user may send a request to communication module 222 from their device, the request being to join the database of independent contractor.

Communication module 222 prompts, on the contractor device, for information descriptive of the first independent contractor. That information, among other things, may include an hourly wage for the first independent contractor. The information descriptive of the first independent contractor may further include one or more of a vehicle make, a vehicle model, a vehicle year, a set of cargo area dimensions, a name, a photograph, a license plate number, a vehicle identification number, contact information, flat fees for particular jobs, and a background check. Note that this information could be most important for a courier independent contractor job, where the contractor must transport goods from one location to another using their own vehicle. As such, other information pertinent to other independent contractor jobs, such as construction experience and tools owned information for a home improvement job, could also be obtained.

The information could also include a schedule of hourly wages. For instance, if the contractor wishes to charge more for weekend jobs, or wishes to charge more during certain points of the business day where traffic and/or demand is likely to be higher, the contractor may define a schedule of hourly wages such that the contractor has complete control of their wage whenever they could potentially be working on a job provided by computing device 210. The flat fees possibly indicated by the contractor could also be set according to such a schedule.

Communication module 222 receives, from the contractor device, a first set of one or more data packets including the information descriptive of the first independent contractor. Account module 220 adds the first independent contractor to database 226 and to the plurality of independent contractors, along with the information descriptive of the first independent contractor.

Communication module 222 receives, from a customer device, a request to view at least a portion of the plurality of independent contractors in database 226. Communication module 222 sends, to the customer device, a second set of one or more data packets including at least the portion of the plurality of independent contractors and respective information for each independent contractor included in the portion of the plurality of independent contractors, with the portion of the plurality of independent contractors including the first independent contractor previously added to the plurality.

In some instances, prior to sending at least the portion of the plurality of independent contractors, account module 220 may sort the portion of the plurality of independent contractors by one or more of a job cost if the job were to be accepted by each respective independent contractor or other specified criteria (e.g., time to complete the job, earliest availability to start the job, customer rating, vehicle size, etc.) to create a sorted list of independent contractors. In the overall example, the sorted list of independent contractors may include the first independent contractor. Communication module 222 may then send the sorted list of independent contractors to the client device.

In other instances, prior to sending at least the portion of the plurality of independent contractors, account module 220 may filter the portion of the plurality of independent contractors by one or more of a job cost if the job were to be accepted by each respective independent contractor or other specified criteria (e.g., time to complete the job, earliest availability to start the job, customer rating, vehicle size, etc.) to create a filtered list of independent contractors. In the overall example, the filtered list of independent contractors includes the first independent contractor. Communication module 222 may then send the filtered list of independent contractors to the client device.

As stated above, one instance where the techniques described herein may be applied are in instances where the independent contractors are couriers privately delivering packages for the customers. In such instances, communication module 222 may receive, from the client device, a set of package dimensions. Account module 220 may then select only independent contractors from the plurality of independent contractors where each cargo area dimension of a set of cargo area dimensions for the respective independent contractor are greater than a corresponding package dimension of the set of package dimensions. In other words, account module 220 would filter out any independent contractor who does not have enough room in the cargo area of their vehicle to safely hold the package the customer is wanting transported. Communication module 222 may then send, to the client device, the selected independent contractors as the portion of the plurality of independent contractors.

With certain jobs, location services may be key to determining costs of the job or time to complete the job. As such, each of the first contractor device and the client device may include a global positioning system (GPS) such that account module 220 may determine locations for each of the first contractor device and the client device.

In such instances, the GPS of the first contractor device may produce data indicative of a location of the first contractor device. The client device may produce data indicative of a location of the client device using either the GPS of the client device or user input received by the client device. Communication module 222 may receive the data indicative of the location of the first contractor device and the data indicative of the location of the client device. Account module 220 may determine a first transportation time for the first independent contractor based on the location of the first contractor device and the location of the client device. For instance, account module 220 may calculate the time it would take for the first independent contractor to reach the client's location. Account module 220 may then calculate a job cost based at least in part on the first transportation time for the first independent contractor and the hourly wage set by the independent contractor, charging the client for the time it would take the first independent contractor to reach the client's location.

In some instances, communication module 222 may receive, from the client device, a job location, either in addition to or in lieu of the client's location. Account module 220 may determine a transportation time for the independent contractor either from the location of the client device to the job location or from the location of the contractor device to the job location. In instances where the contractor is delivering a package, this calculation would take into account the time it would take for the contractor to travel from the package pickup location (e.g., the client's location) to the package delivery location (e.g., the job location). In other instances where the contractor needs to perform a job at a job site (e.g., the job location), this calculation would take into account the time it would take for the contractor to travel to the job location. As such, calculating the job cost includes account module 220 calculating the job cost based at least in part on the first transportation time, the second transportation time, and the hourly wage. Other considerations for the job cost include any flat fees indicated by the contractor.

In either of these instances, communication module 222 may send, to the client device, any of the calculated transportation times for display along with an indication of the first independent contractor. In this way, the client understands the time associated with the job in addition to the monetary costs.

In determining the transportation times, account module 220 may access a navigation application. Account module 220 may input a starting location (e.g., the contractor location or the client location) and an ending location (e.g., the client location or the job location) into the navigation application. Account module 220 may also enter all of the locations into a multi-stop navigation estimator. Account module 220 may receive, from the navigation application, an estimated travel time from the starting location to the ending location (including any possible stops in between). Account module 220 may then assign the estimated travel time as the transportation time in calculating the job cost.

In other instances where a navigation application is not used, account module 220 may first determine a driving distance between a starting location and an ending location (including any possible stops in between). Account module 220 may also determine an expected average driving speed for an area that includes the starting location and the ending location. Account module 220 may then calculate the transportation time based at least in part on the driving distance and the expected average driving speed (e.g., dividing the distance by the expected speed).

The techniques of this disclosure may allow for customer rating and feedback. Communication module 222 may prompt the client device for a job rating for the first independent contractor when the first independent contractor does a job for the client. Communication module 222 may receive a job rating for the first independent contractor and adjust a user rating stored in database 226 for the first independent contractor based on the job rating.

As described above, the techniques of this disclosure may be applied to courier services. However, to ensure the legality of the operation, communication module 222 may receive an explicit indication that a job for the first independent contractor does not involve contraband. Contraband can include one or more of drugs, alcohol, firearms, explosives, wildlife, military applications, cultural artifacts, domestic animal fur, gold coins, and pets, or any other item that may be deemed illegal, that may be typically associated with crime, or that may require special handling from a licensed or trained individual.

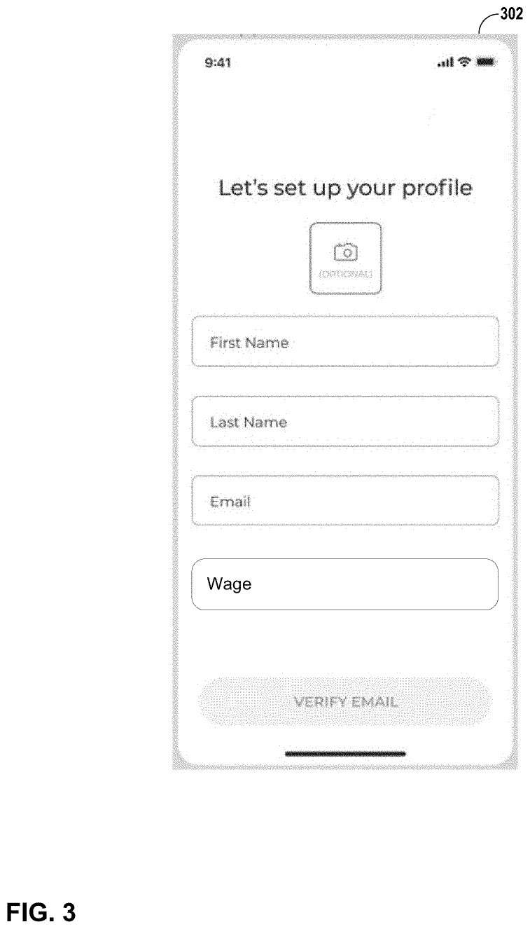

FIGS. 3-10 include example user interfaces (UIs) to be displayed by one or more of a client device (e.g., customer device 104) and a contractor device (e.g., contractor device 106) during the execution of one or more techniques described herein. Any ornamental style presented by these example UIs are merely examples of possibly styles for such UIs, and other presentations that accomplish the functions described herein are understood to be simple design choices rather than altering the functionality of the technology. In other words, the techniques described herein may be applied by a number of different types of UIs while still falling within the metes and bounds of this disclosure.

FIG. 3 is a conceptual diagram illustrating an example user interface 302 for registering an independent contractor, in accordance with the techniques described herein. At a minimum, during the registration process, an independent contractor may define the wage they wish to be paid during each unit of time (e.g., dollars per hour, cents per minute, etc.). In the example of FIG. 3, the user may also include a profile picture, a name, and contact information, such as an email address or a phone number. In some instances, UI 302 may include prompts for other information, including a vehicle make, a vehicle model, a vehicle year, a set of cargo area dimensions, a license plate number, a vehicle identification number, and a background check.

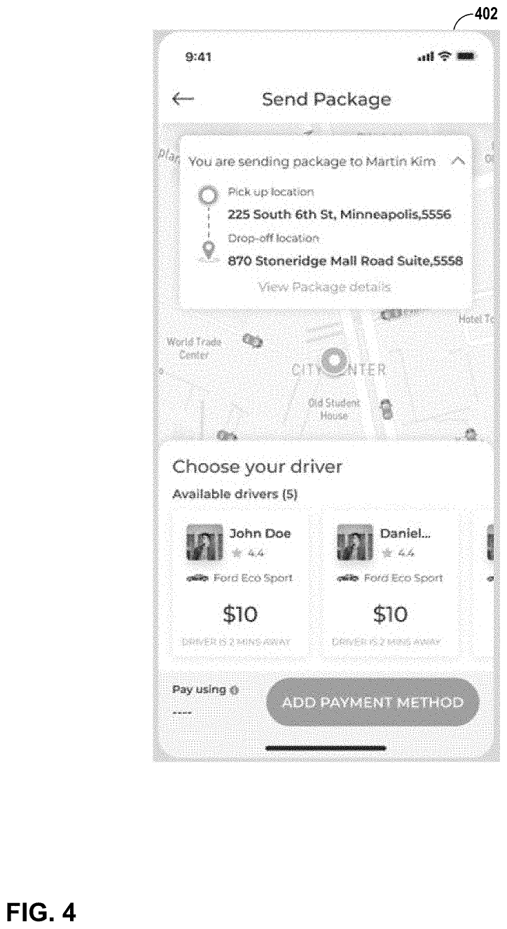

FIG. 4 is a conceptual diagram illustrating an example user interface 402 for matching an independent contractor with a customer, in accordance with the techniques described herein. UI 402 may be shown on customer device 104. As shown in FIG. 4, UI 402 depicts a pick-up location for the job, a drop-off location for the job, and the location of a number of potential independent contractors in relation to the pick-up location. Based on these locations and the availability of drivers, UI 402 presents a number of cards corresponding to the car icons depicting the locations of the drivers. These cards are selectable by a user of customer device 104 to initiate the start of a job by the independent contractor depicted in the card for the user of customer device 104.

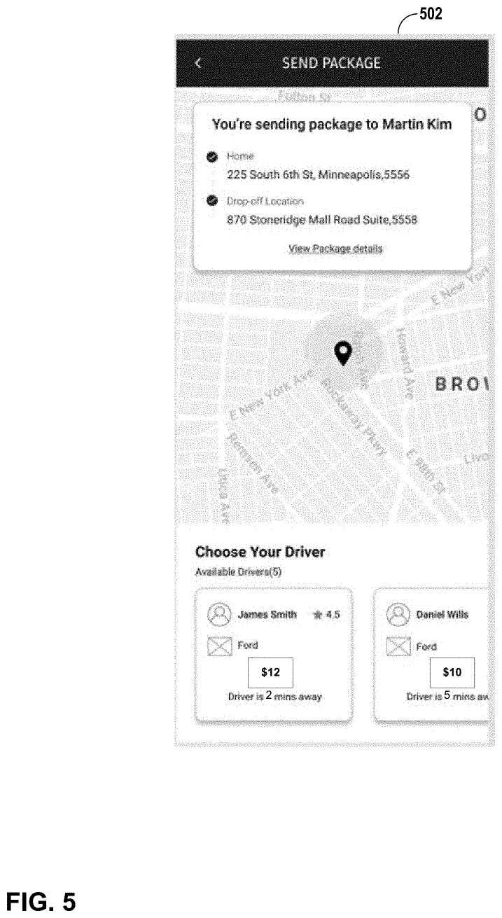

FIG. 5 is a conceptual diagram illustrating an example user interface 502 for sorting a list of independent contractors, in accordance with the techniques described herein. By default, when a UI is presented to a user showing potential independent contractors, the UI may present the list of independent contractors sorted by a default criteria, such as price or time it would take for the independent contractor to arrive at the pick-up location. For instance, in UI 502, the potential drivers are sorted by distance away from the pick-up location (e.g., “James Smith” is 2 minutes away from the pick-up location, while “Daniel Wills” is 5 minutes away), even though the closer driver may be more expensive than the driver who is further away.

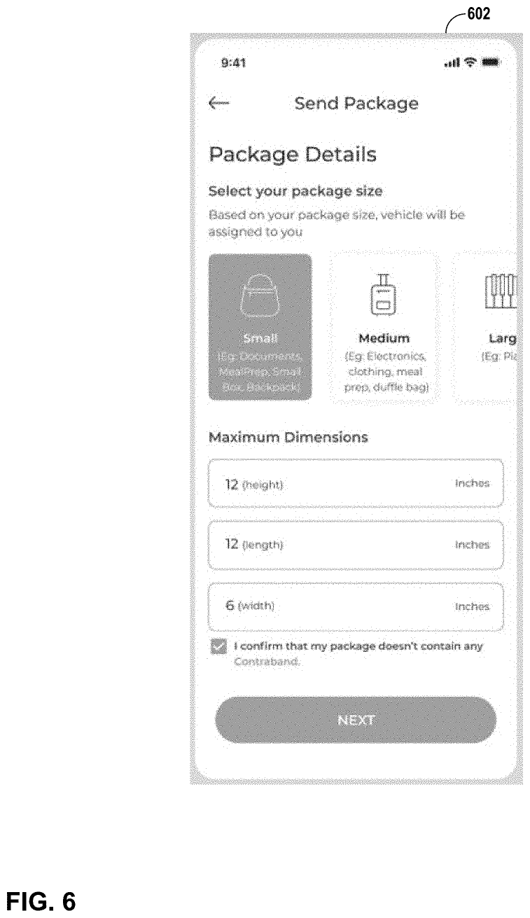

FIG. 6 is a conceptual diagram illustrating an example user interface 602 for filtering a list of independent contractors, in accordance with the techniques described herein. In the example of UI 602, the filtering mechanism may be based on a package intended to be transported by the independent contractor. As it would be troublesome to a customer to show vehicles that may not be able to accommodate certain sized packages, a user may be able to enter package dimensions into UI 602 to ensure that vehicles that cannot accommodate that package are excluded from the ultimate list. The customer may select a default package size or may enter custom dimensions into UI 602. In other examples, the user may filter by other criteria, such as contractor rating, price limits, time limits, vehicle type, or any other criteria important to the performance of the intended job.

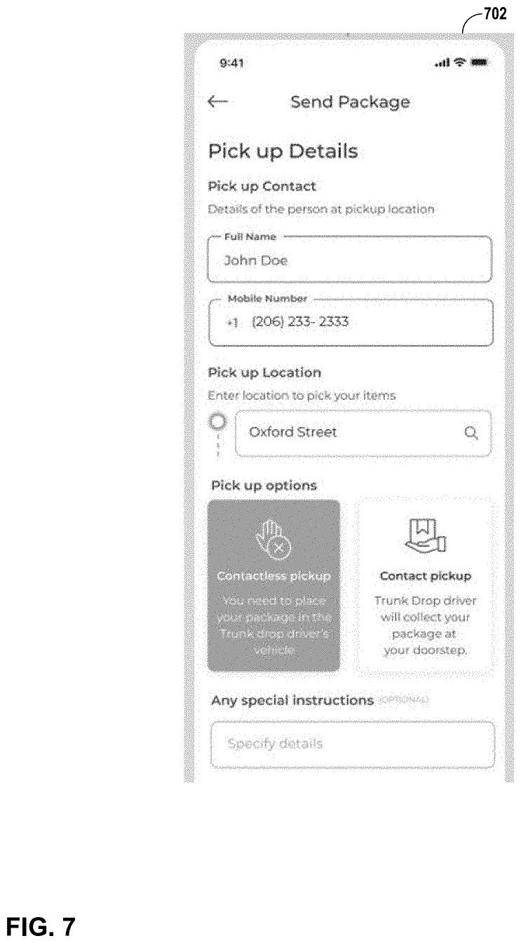

FIG. 7 is a conceptual diagram illustrating an example user interface 702 for using location services in the independent contractor-customer matching process, in accordance with the techniques described herein. While contractor device 106 may simply utilize regular GPS pings to define their location for the purposes of the techniques described herein, the user of customer device 104 may define their locations in a number of different ways. In some instances, the user may enter their location into UI 702 in the pick-up location field. In other instances, the user may select the icon next to the field to activate location services to automatically detect customer device 104′s location. UI 702 also provides the user with the option to select whether they wish to place the package in the cargo area of the independent contractor's vehicle themselves (thereby making the pickup contactless for the independent contractor), or whether they want the independent contractor to collect the package themselves (thereby making the pickup a contact pickup for the independent contractor).

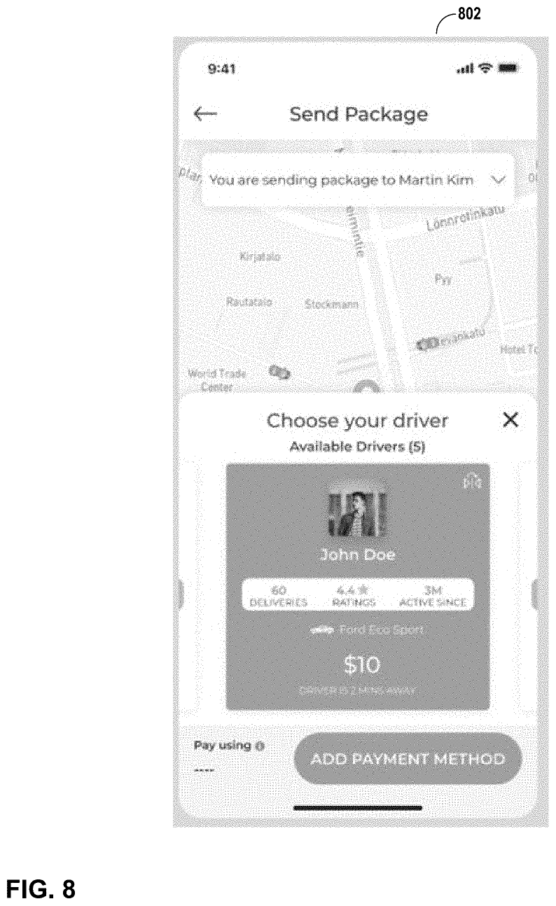

FIG. 8 is a conceptual diagram illustrating an example user interface 802 for pricing a job, in accordance with the techniques described herein. UI 802 shows the customer's location via the circle icon in the middle of UI 802, and also shows the intended recipient as a saved address for a “Martin Kim”. After selecting the independent contractor card for “John Doe”, an expanded graphic is shown in UI 802 with a total price for the intended job. Also shown in UI 802 is information about “John Doe” and their past jobs, including how many jobs they have performed, a rating for the independent contractor, and how long the independent contractor has been performing jobs using this service, although other information could be shown in other example UIs.

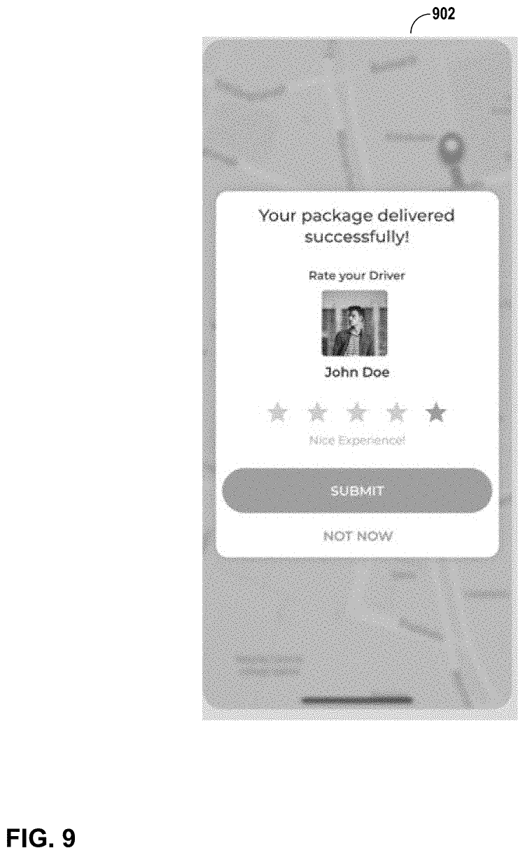

FIG. 9 is a conceptual diagram illustrating an example user interface 902 for rating an independent contractor after a job has completed, in accordance with the techniques described herein. As shown in UI 902, an alert indicating that the job has been completed is shown. In UI 902, the customer is able to select a star rating for the job and submit that for the independent contractor's universal rating history.

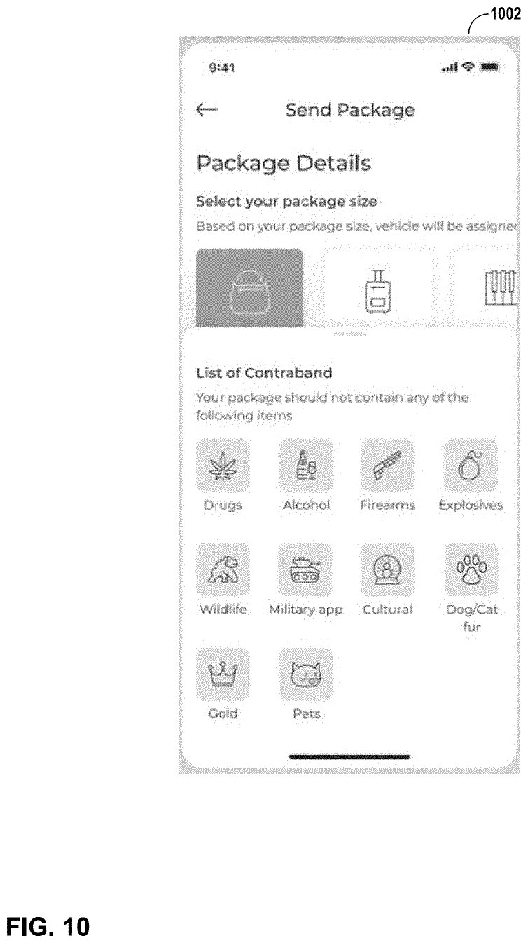

FIG. 10 is a conceptual diagram illustrating an example user interface 1002 for notifying the customer about contraband, in accordance with the techniques described herein. For jobs where the independent contractor is being asked to transport a package from one location to another, there may be legal concerns if the independent contractor were being asked to transport illegal or otherwise illicit material. As such, UI 1002 may present the user of customer device 104 with a listing of material that should not be transported. While UI 1002 includes contents such as drugs, alcohol, firearms, explosives, wildlife, military material, cultural items, furs, gold, and pets, UI 1002 may include any other contents which may be dangerous, illegal, or otherwise dangerous for the independent contractor to transport due to a lack of authority or training.

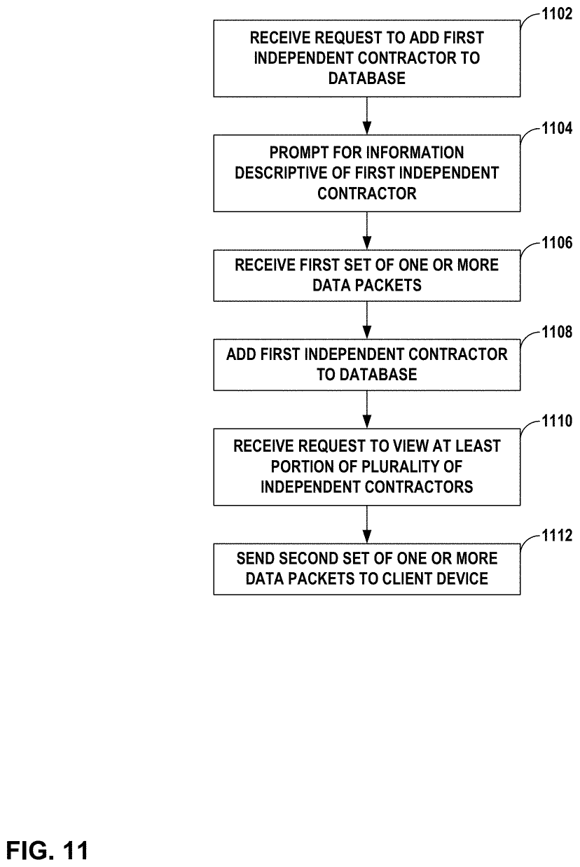

FIG. 11 is a flow chart illustrating an example mode of operation. The techniques of FIG. 11 may be performed by one or more processors of a computing device, such as server device 110 of FIG. 1 and/or computing device 210 illustrated in FIG. 2. For purposes of illustration only, the techniques of FIG. 11 are described within the context of computing device 210 of FIG. 2, although computing devices having configurations different than that of computing device 210 may perform the techniques of FIG. 11.

In accordance with the techniques described herein, communication module 222 receives, from a contractor device, a request to add a first independent contractor to database 226, which includes a plurality of independent contractors (1102). Communication module 222 prompts, on the contractor device, for information descriptive of the first independent contractor (1104). That information, among other things, may include an hourly wage for the first independent contractor. Communication module 222 receives, from the contractor device, a first set of one or more data packets including the information descriptive of the first independent contractor (1106). Account module 220 adds the first independent contractor to database 226 and to the plurality of independent contractors (1108). Communication module 222 receives, from a customer device, a request to view at least a portion of the plurality of independent contractors in database 226 (1110). Communication module 222 sends, to the customer device, a second set of one or more data packets including at least the portion of the plurality of independent contractors and respective information for each independent contractor included in the portion of the plurality of independent contractors, with the portion of the plurality of independent contractors including the first independent contractor previously added to the plurality (1112).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method for connecting independent contractors to clients, the method comprising:
receiving, by a server device and from a first contractor device, a request to add a first independent contractor to a database including a plurality of independent contractors;
prompting, by the server device and on the first contractor device, for information descriptive of the first independent contractor, wherein the information includes an hourly wage for the first independent contractor;
receiving, by the server device and from the first contractor device, a first set of one or more data packets including the information descriptive of the first independent contractor;
adding, by the server device, the first independent contractor to the database and the plurality of independent contractors;
receiving, by the server device and from a client device, a request to view at least a portion of the plurality of independent contractors; and
sending, by the server device and to the client device, a second set of one or more data packets including at least the portion of the plurality of independent contractors and respective information for each independent contractor included in the portion of the plurality of independent contractors, wherein the portion of the plurality of independent contractors includes the first independent contractor.

2. The method of claim 1, wherein the first contractor device and the client device each include a global positioning system (GPS), and wherein the method further comprises:
producing, by the GPS of the first contractor device, data indicative of a location of the first contractor device;
producing, by the client device, data indicative of a location of the client device using either the GPS of the client device or user input received by the client device;
receiving, by the server device, the data indicative of the location of the first contractor device and the data indicative of the location of the client device;
determining, by the server device, a first transportation time for the first independent contractor based on the location of the first contractor device and the location of the client device; and
calculating, by the server device, a job cost based at least in part on the first transportation time for the first independent contractor and the hourly wage set by the independent contractor.

3. The method of claim 2, further comprising:
receiving, by the server device and from the client device, a job location; and
determining, based on the location of the client device, a second transportation time for the independent contractor from the location of the client device to the job location,
wherein calculating the job cost comprises calculating the job cost based at least in part on the first transportation time, the second transportation time, and the hourly wage.

4. The method of claim 2, further comprising:
sending, by the server device and to the client device, the first transportation time for display along with an indication of the first independent contractor.

5. The method of claim 1, further comprising:
prior to sending at least the portion of the plurality of independent contractors, sorting, by the server device, the portion of the plurality of independent contractors by one or more of job cost for each respective independent contractor or other specified criteria to create a sorted list of independent contractors, wherein the sorted list of independent contractors includes the first independent contractor,
wherein sending at least the portion of the plurality of independent contractors comprises sending the sorted list of independent contractors.

6. The method of claim 1, wherein the information descriptive of the first independent contractor further includes one or more of a vehicle make, a vehicle model, a vehicle year, a set of cargo area dimensions, a name, a photograph, a license plate number, a vehicle identification number, contact information, and a background check.

7. The method of claim 1, further comprising:
receiving, by the server device, a job rating for the first independent contractor; and
adjusting, by the server device, a user rating for the first independent contractor based on the job rating.

8. The method of claim 1, further comprising:
receiving, by the server device and from the client device, a set of package dimensions;
selecting, by the server device, only independent contractors from the plurality of independent contractors where each cargo area dimension of a set of cargo area dimensions for the respective independent contractor are greater than a corresponding package dimension of the set of package dimensions; and
sending, by the server device and to the client device, the selected independent contractors as the portion of the plurality of independent contractors.

9. The method of claim 1, further comprising:
receiving, by the server device, an explicit indication that a job for the first independent contractor does not involve contraband.

10. The method of claim 9, wherein contraband includes one or more of drugs, alcohol, firearms, explosives, wildlife, military applications, cultural artifacts, domestic animal fur, gold coins, and pets.

11. The method of claim 1, wherein the first contractor device includes a global positioning system (GPS), and wherein the method further comprises:
producing, by the GPS of the first contractor device, data indicative of a location of the first contractor device;
receiving, by the server device, the data indicative of the location of the first contractor device and data indicative of a job location;
determining, by the server device, a first transportation time for the first independent contractor based on the location of the first contractor device and the job location; and
calculating, by the server device, a job cost based at least in part on the first transportation time for the first independent contractor and the hourly wage set by the independent contractor.

12. The method of claim 1, wherein the client device includes a global positioning system (GPS), and wherein the method further comprises:
producing, by the client device, data indicative of a location of a user using either the GPS of the client device or user input received by the client device;
receiving, by the server device, the data indicative of the location of the user and data indicative of a job location;
determining, by the server device, a first transportation time for the first independent contractor based on the location of the user and the job location; and
calculating, by the server device, a job cost based at least in part on the first transportation time for the first independent contractor and the hourly wage set by the independent contractor.

13. The method of claim 12, wherein determining the first transportation time comprises:
accessing, by the server device, a navigation application;
inputting, by the server device, a starting location and an ending location into the navigation application;
receiving, by the server device and from the navigation application, an estimated travel time from the starting location to the ending location;
assigning, by the server device, the estimated travel time as the first transportation time.

14. The method of claim 12, wherein determining the first transportation time comprises:
determining, by the server device, a driving distance between a starting location and an ending location;
determining, by the server device, an expected average driving speed for an area that includes the starting location and the ending location; and
calculating, by the server device, the first transportation time based at least in part on the driving distance and the expected average driving speed.

15. The method of claim 1, further comprising:
prior to sending at least the portion of the plurality of independent contractors, filtering, by the server device, the portion of the plurality of independent contractors by one or more of job cost for each respective independent contractor or other specified criteria to create a filtered list of independent contractors, wherein the filtered list of independent contractors includes the first independent contractor,
wherein sending at least the portion of the plurality of independent contractors comprises sending the filtered list of independent contractors.

16. A device comprising:
a memory configured to store a database; and
a processor configured to:
receive, from a first contractor device, a request to add a first independent contractor to the database including a plurality of independent contractors;
prompt, on the first contractor device, for information descriptive of the first independent contractor, wherein the information includes an hourly wage for the first independent contractor;
receive, from the first contractor device, a first set of one or more data packets including the information descriptive of the first independent contractor;
add the first independent contractor to the database and the plurality of independent contractors;
receive, from a client device, a request to view at least a portion of the plurality of independent contractors; and
send, to the client device, a second set of one or more data packets including at least the portion of the plurality of independent contractors and respective information for each independent contractor included in the portion of the plurality of independent contractors, wherein the portion of the plurality of independent contractors includes the first independent contractor.

17. The device of claim 16, wherein the processor is further configured to:
prior to sending at least the portion of the plurality of independent contractors, sort the portion of the plurality of independent contractors by one or more of job cost for each respective independent contractor or other specified criteria to create a sorted list of independent contractors, wherein the sorted list of independent contractors includes the first independent contractor,
wherein sending at least the portion of the plurality of independent contractors comprises sending the sorted list of independent contractors.

18. The device of claim 16, wherein the processor is further configured to:
receive, from the client device, a set of package dimensions;
select only independent contractors from the plurality of independent contractors where each cargo area dimension of a set of cargo area dimensions for the respective independent contractor are greater than a corresponding package dimension of the set of package dimensions; and
send, to the client device, the selected independent contractors as the portion of the plurality of independent contractors.

19. A non-transitory computer-readable storage medium having stored thereon instructions that, when executed, cause one or more processors of a computing device to:
receive, from a first contractor device, a request to add a first independent contractor to a database including a plurality of independent contractors;
prompt, on the first contractor device, for information descriptive of the first independent contractor, wherein the information includes an hourly wage for the first independent contractor;
receive, from the first contractor device, a first set of one or more data packets including the information descriptive of the first independent contractor;
add the first independent contractor to the database and the plurality of independent contractors;
receive, from a client device, a request to view at least a portion of the plurality of independent contractors; and
send, to the client device, a second set of one or more data packets including at least the portion of the plurality of independent contractors and respective information for each independent contractor included in the portion of the plurality of independent contractors, wherein the portion of the plurality of independent contractors includes the first independent contractor.

20. The non-transitory computer-readable storage medium of claim 19, wherein the instructions, when executed, further cause the one or more processors to:
receive, from the client device, a set of package dimensions;
select only independent contractors from the plurality of independent contractors where each cargo area dimension of a set of cargo area dimensions for the respective independent contractor are greater than a corresponding package dimension of the set of package dimensions; and
send, to the client device, the selected independent contractors as the portion of the plurality of independent contractors.
